(19) United States
(12) Patent Application Publication
(10) Pub. No.: US 2008/0122996 A1
(43) Pub. Date: May 29, 2008

(54) Off-axis projection system

(75) Inventor: Akihiro Mochizuki, Louisville, CO (US)

Correspondence Address: MORRISON & FOERSTER LLP, 1650 TYSONS BOULEVARD, SUITE 400, MCLEAN, VA, 22102, US

(73) Assignee: Nano Loa, Inc., Kawasaki-shi (JP)

(21) Appl. No.: 11/605,315

(22) Filed: Nov. 29, 2006

(51) Int. Cl. G02F 1/1335

(52) U.S. Cl. 349/5

(57) ABSTRACT

A projection display system comprising: a liquid crystal display panel comprising at least a pair of substrates; and a liquid crystal material disposed therebetween; and projection means comprising an off-axis incident light source.

### BACKGROUND OF THE INVENTION

1. Field of the Invention

The present invention relates to a liquid crystal projection system, specifically an off-axis incident light liquid crystal projection system utilizing PSS-LCD panels for extremely inexpensive projection system with high performance display quality.

2. Related Background Art

1.2. Background of the Invention as a Primary Demand

Recent emerging development of liquid crystal display (LCD) devices for TV application is outstanding. This new application of LCDs for TV, at the same time, requires higher display performance than ever used at LCDs. High viscous smectic liquid crystal materials potentially realize high image quality required for TV application. In particular, projection display systems using liquid crystal display panels as image forming panels show significant cost performance in their performance. Among projection display systems, a rear projection system utilizing liquid crystal display (LCD) panels are widely used for large screen projection TV sets, such as with 60-inch, and larger screen sizes. Optically enlarged screen is one of the most benefits of the projection display using a small LCD panel in terms of manufacturing cost per unit screen size, such as per inch diagonal cost of the TV sets. Thanks to an optical magnification of the projection TV sets, the LCD panel base projection TV sets enables lower manufacturing cost than that of direct view flat panel TV sets, such as Plasma Display Panel (PDP), and direct view large LCD panel TV sets.

Even though an LCD panel base projection TV set has such a beautiful point in terms of significant cost benefit, its slow optical response, in particular inter-gray scale slow response prevents the projection system from taking major market in large screen TVs. In particular, large screen TVs, the image velocity is in proportion to screen diagonal size. Compared to 4-inch diagonal screen and 40-inch diagonal screen, 40-inch screen needs 10 times faster image velocity than that for 4-inch. Because, TV image is formed by each frame. Usually, each frame has 16.7 ms time period, which is for 60 Hz of frame rate case. Regardless screen diagonal size, each frame has to display a fame screen in 16.7 ms. Therefore, as illustrated in FIG. 1, an airplane has to travel about 4-inch distance in a single frame that is 16.7 ms. On the contrary, an airplane needs to travel about 40-inch distance in a single frame that is 16.7 ms in the 40-inch screen. This difference in screen image between 4-inch and 40-inch creates significant difference in their requirement for optical response, in particular for inter-gray scale optical response.

Faster optical response is the critical requirement for large projection displays in terms of keeping well enough full motion image quality.

1.3 Background of the Invention as Secondary Demand

As discussed above, mfg cost benefit is the primary advantage of the LCD base projection displays Not necessary to say, without well enough image quality, in particular full motion video image with fast enough inter-gray scale optical response, even significant low mfg cost would not appeal the projection display system as a favorite TV set for consumer. Therefore, fast enough optical response, in particular fast enough inter-gray optical response is the most necessary for an LCD panel base projection displays.

1.4 Background of the Invention as Thirdly Demand

Once, fast enough optical response is established in an LCD panel base projection display system, next demand is further cost advantage compared to other competitive technologies such as PDP-TVs, direct view type of large screen LCD-TVs.

Current conventional LCD panel base rear projection TV sets are consists of three-LCD panels: one for Green light, one for Red light, and the other is for Blue light. Each LCD panel makes each primary color image and converts each image on the projection screen, resulting in full-color video image. Therefore, this conventional LCD base projection system requires three LCD panels, and their equivalent optical component such as polarized beam splitters, half mirrors, and image conversion system. Due to precise polarized beam treatment, polarized beam splitter is very expensive. Moreover, due to RGB beam conversion in very high resolution system, its image conversion requires very tight optical adjustment. These factors push up mfg cost of the LCD base projection system. On the contrary, if single LCD panel provides fast enough, in particular fast enough inter-gray scale optical response, many of expensive optical component such as polarized beam splitters, half mirrors will be eliminated, resulting in lower mfg cost. Moreover, avoiding complicated image conversion process, mfg cost is highly expected to be much lower than that of current achievable cost.

### SUMMARY OF THE INVENTION

2. Technical Problem to Be Solved

As described above, two independent technical issues must be solved to overcome current problems at LCD panel base rear projection display systems. First technical issue is to establish fast enough optical response, in particular at inter-gray scale optical response. Second technical issue is to eliminate expensive optical component keeping well enough image quality at projection screen.

2.1 First Enough Optical Response for Projection System

Unlike direct view type of LCDs, most of LCD panel base projection displays have faster optical response than that of direct view LCDs. Operational temperature of the projection display allows higher environmental temperature than that for direct view LCDs. This somewhat elevated temperature helps to have faster optical response. A typical environmental temperature for rear projection LCD system is 60 degrees C. This elevated temperature allows almost two times faster optical response than that at room temperature. Even this two times faster optical response is not well enough for full motion video image, in particular for inter-gray scale optical response. A typical inter-gray scale optical response of conventional nematic base LCDs is 20 ms. Sometimes it takes over 25 ms. Due to applied voltage limitation of high temperature poly-Si TFTs which are commonly used for LCD base rear projection system, maximum applied voltage is limited to 5 V. This limited applied voltage also makes restriction for optical response to conventional nematic base LCD projection system. Due to required extremely high resolution TFTs, high temperature poly-Si TFT is the most promising backplane to drive liquid crystal medium. Therefore, it is the most required to realize much faster optical response with low drive voltage provided by high temperature poly-Si TFTS.

2.2 Elimination of Expensive Optical Component

This second requirement is more complicated to solve. As discussed at 1.4, much faster optical response LCD panel will eliminate three-LCD panel solution, resulting in possible elimination of many of expensive optical component from projection system. However, as long as applying conventional optical system, still expensive polarized beam splitter and expensive half mirrors are required. Introducing fast enough optical response LCD panel, single-LCD panel optical system will be possible by field sequential color method. Among optical component including LCD panel, the most expensive one is a polarized beam splitter. Moreover, as long as using a polarized beam splitter, applicable optical design is almost fixed due to required incident angle to the polarized beam splitter. This limited design freedom in optical system, also restricts total optical design of LCD base rear projection system. Therefore, elimination of polarized beam splitters is of most important requirement to solve secondary technical issue.

3. Method to Solve the Technical Issues

The above technical issues are investigated to solve. Two major problems are investigated. One is method to achieve fast enough optical response including inter-gray optical response which is well enough to realize field sequential color system with single LCD panel. The other is to eliminate polarized beam splitters and half mirrors those are most expensive optical elements and restrict design freedom in an LCD base rear projection TV system.

3.1. Obtaining Fast Enough Optical Response

Because of requirement for full motion video image reproduction with pretty much saturated natural colors at a rear projection TV set, not only fast optical response, but also continuous gray scale capability is of most required in terms of compatibility with high temperature poly-Si TFTs. Using monolithic silicon wafer, so-called digital gray scale is applicable with using binary type of fast optical response LCD such as ferroelectric liquid crystal displays or FLCDs. However, monolithic silicon wafer provides only reflective projection system. Due to non-transmissive performance of visible light wavelength of silicon wafer, reflective projection system is only possible way for this solution. Moreover, even monolithic silicon enables very fast addressing of each pixel element to drive liquid crystal at each pixel, digital gray scale requires extremely fast signal processing. Also, limited optical response of FLCDs, even digital gray scale needs dithering and/or additional further gray scale creation to meet with requirement of natural color saturation.

As a matter of fact, current digital gray scale could not achieve fast enough, saturated enough and inexpensive enough rear projection system solution. Therefore, it is obvious that so called analog gray scale or current conventional LCD compatible gray scale with extremely fast optical response is the only possible solution to meet with this particular requirement.

PSS-LCD technology as introduced by US patent filling (No. 20040196428) is current only possible way to realize fast enough analog gray scale response. Moreover, PSS-LCD technology is fully compatible with current conventional nematic base LCDs, which means electronics such as LCD driver ICs, and signal controlling processors are fully compatible with commercially available ones. This fact suggests that at least electronics portion is inexpensive enough including high temperature poly-Si TFT backplane due to sharing conventional electronics design. Because of compatibility of PSS-LCDs with conventional nematic base LCDs, even monolithic silicon backplanes, or LCOS backplanes are also applicable as they are. Therefore, PSS-LCD does not only realize fast enough inter-gray scale optical response, but also realizes inexpensive enough solution for single-panel rear projection TV system.

3.2 Elimination of Expensive Optical Component

The Inventor considered the intrinsic requirement of those expensive optical components. As illustrated in FIG. 2, allowable incident light angle to a conventional LCD panel is the most outstanding restriction. For instance, using continuous white light source, FIG. 2 shows allowable incident light angle to the LCD panel. FIG. 3 shows possible incident beam system to the LCD panel using RGB LED or Laser beam light source. It is clear that both ways still require polarized beam splitters and half mirrors to introduce well enough incident light to the LCD panel. FIG. 4 illustrates case of LCOS, or reflective LCD panel case. This case is also clear that polarized beam splitter and half mirrors are of most necessary.

FIGS. 2, 3 and 4 suggest that limited incident angle to the LCD panel, which is vertical incident angle to the LCD panel causes this limited incident beam angle requirement, resulting in need of expensive optical elements. Therefore, it is obvious that incident light beam from light source could come to LCD panel with off-axis as illustrated in FIG. 5, expensive optical elements such as polarized beam splitters, half mirrors are eliminated from the projection system. Although this is obvious, current conventional LCDs are well known of their strong dependence of light throughput from incident light angle. In short, off-axis incident to the conventional LCD panel does not provide well enough light throughput. This is fatal problem for projection display application due to lose of screen brightness.

Again, PSS-LCD technology which was invented by the Inventor of this patent application is clear to provide very practical solution to solve this particular technical requirement. FIG. 6 illustrates incident angle dependence of light throughput of PSS-LCD. As shown in FIG. 6, it is very clear that PSS-LCD provides over 80% of light throughput to the off-axis incident light beam such as 30 degrees from normal to the LCD panel. This means that PSS-LCD panel does not limit incident light beam angle vertical to the panel, In particular, deep off-axis allowance shown in FIG. 5 enables to eliminate use of polarized beam splitters, and half mirrors. From FIG. 6, it is clear that even an incident angle is 20 degrees from normal to LCD panel plane, nearly 90% of light throughput is obtained. The incident light angle and light throughput have trade-off relationship. Larger off-axis angle of incident light angle provides lower light throughput. However, the light throughput reduction due to the incident light angle is very small compared to that of conventional LCD displays. For instance, a conventional TN-LCD panel reduces light throughput less than half of the panel normal angle, than with the 10 degrees of off-axis incident light angle of conventional TN-LCD panel.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 shows image velocity dependent on screen diagonal size.

FIG. 2 shows incident light angle to a conventional LCD panel for a three-panel projection system.

FIG. 3 shows incident light angle to a conventional LCD panel for a single-panel projection system.

FIG. 4 shows incident light angle to a conventional LCoS display panel.

FIG. 5 shows an off-axis incident light angle system.

FIG. 6 shows incident light angle dependence of light throughput of a PSS-LCD panel.

FIG. 7 shows a timing chart for total frame rate of 120 Hz.

FIG. 8 shows a sub-frame system for a digital gray scale method.

FIG. 9 shows an 8-divided sub-pixel system.

FIG. 10 shows a digital gray scale by pulse width modulation.

FIG. 11 shows a different optical set-up for an off-axis optical system.

FIG. 12 shows a relationship between the incident light angle and mesrurement light angle for determining Light efficiency for Example 1 in Table 1 (This Invention).

FIG. 13 shows a relationship between the incident light angle and mesrurement light angle for determining Light efficiency for Example 2 in Table 2 (Control).

FIG. 14 shows a relationship between the incident light angle and mesrurement light angle for determining Light efficiency for Example 3 in Table 3 (This Invention).

FIG. 15 shows a relationship between the incident light angle and mesrurement light angle for determining Light efficiency for Example 4 in Table 4 (Control).

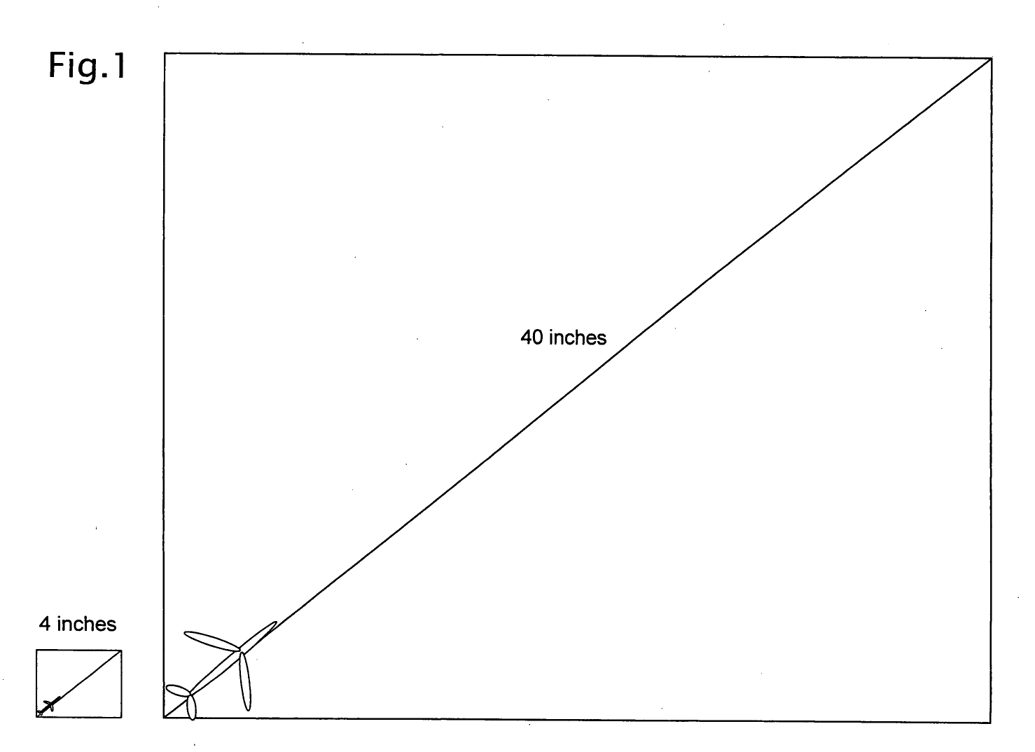

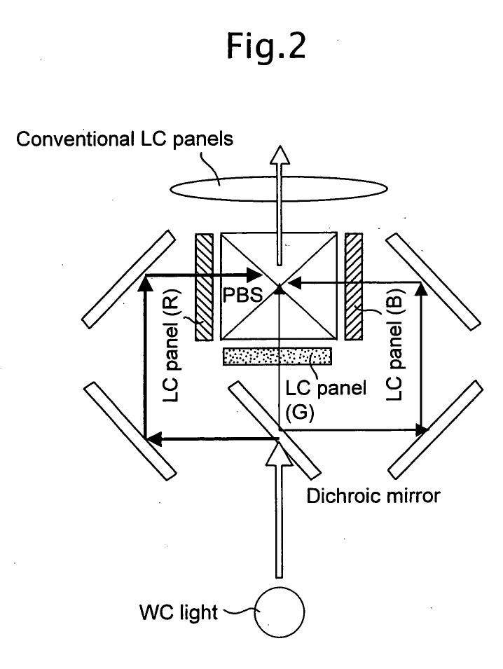

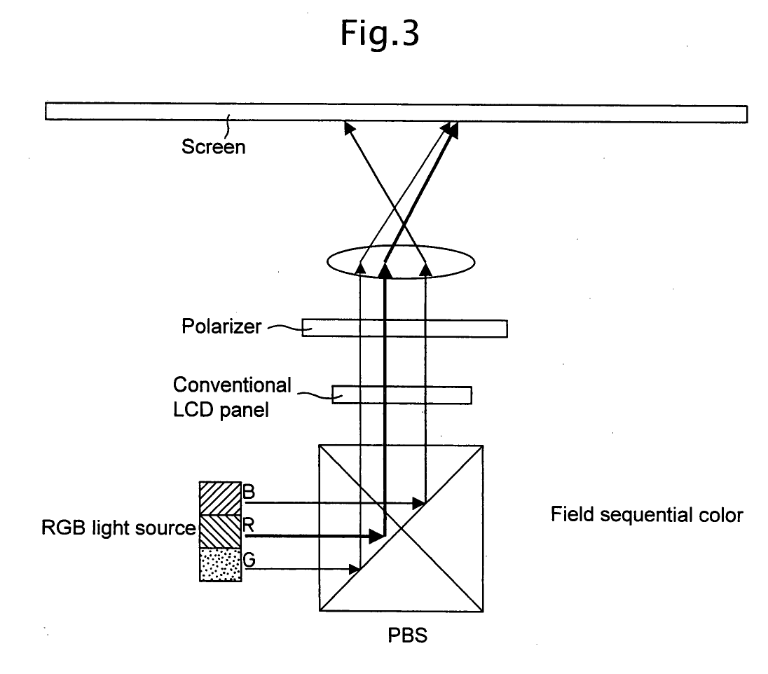

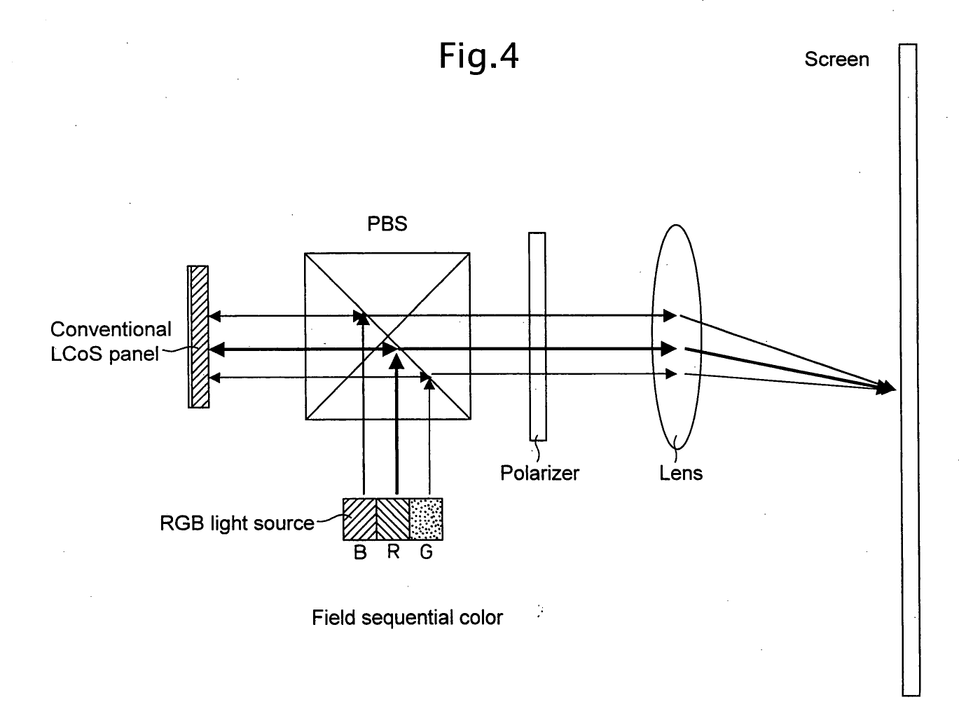

### DETAILED DESCRIPTION OF PREFERRED EMBODIMENTS

Hereinbelow, the present invention will be described in detail with reference to the accompanying drawings, as desired. In the following description, “%” and “part(s)” representing a quantitative proportion or ratio are those based on mass, unless otherwise noted specifically.

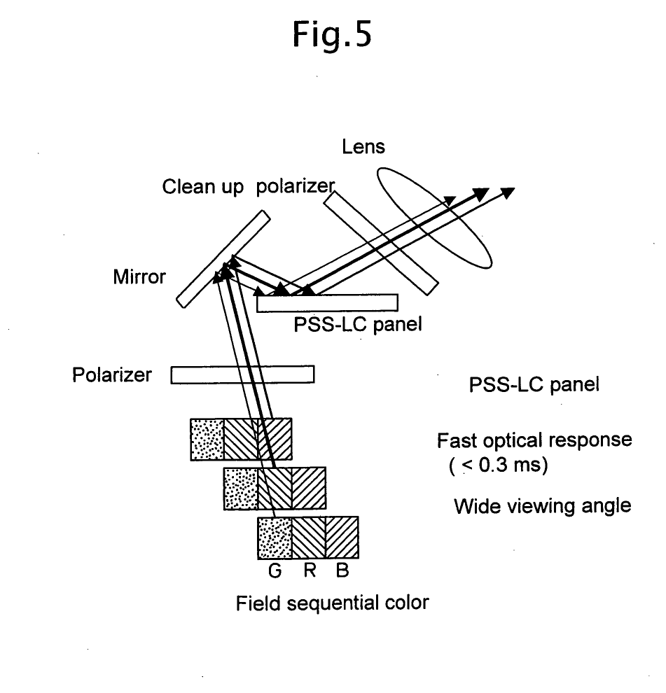

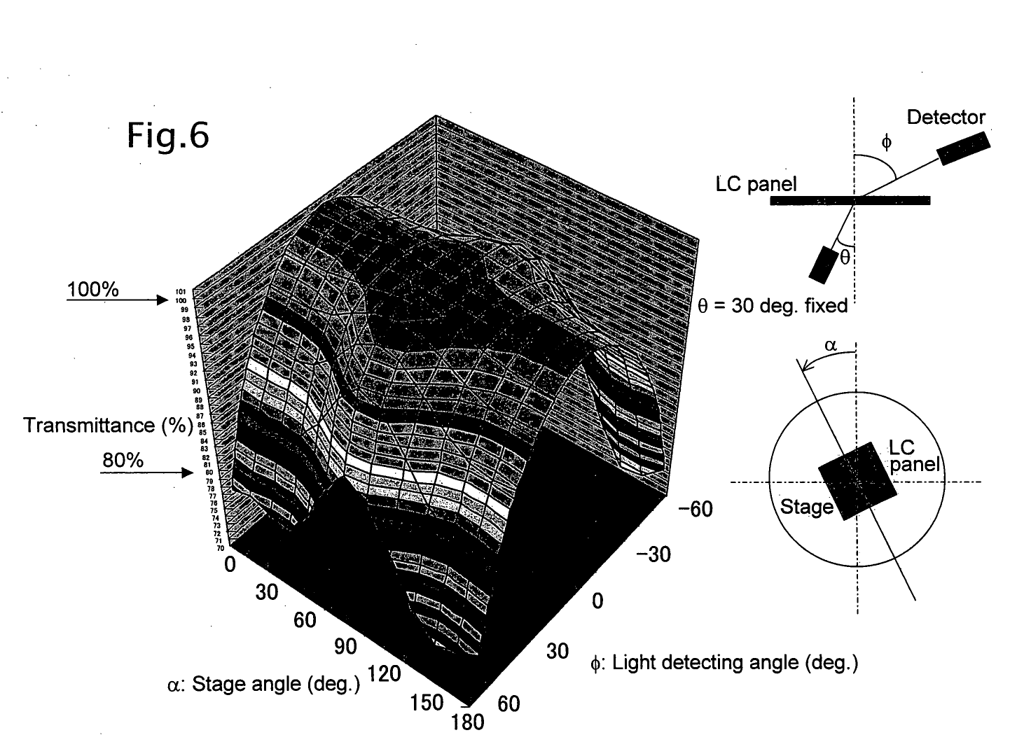

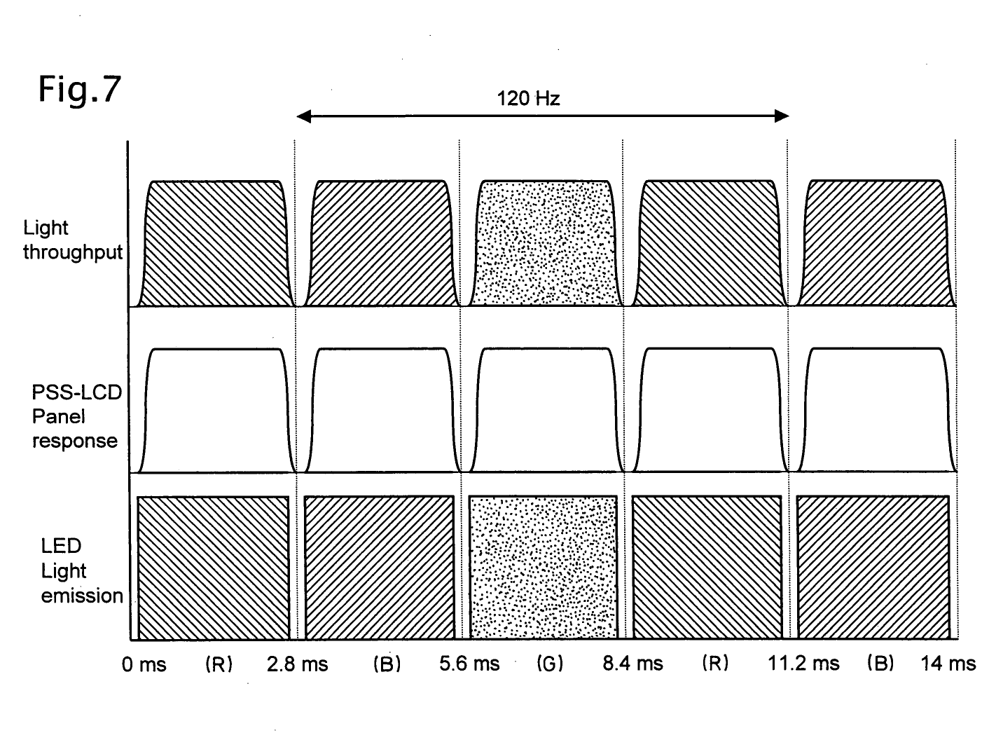

Using extremely wide viewing angle performance of PSS-LCDs as well as RGB primary color projection light sources, an off-axis incident beam angle projection system is realized without losing significant light throughput. FIG. 5 presents the concept of this Invention. As illustrated in FIG. 5, which is an actual measured result of a PSS-LCD panel in terms of viewing angle dependence of light throughput, PSS-LCD panels have an extremely wide viewing angle, or keep well enough light throughput to an off-axis incident light. Using this particular characteristic properties of PSS-LCD panels, an extremely off-axis incident light optical system works for practical projection system without using expensive and complicated optical design just shown in FIG. 5. Using RGB primary color light source, each primary color light source emits time sequentially, just like Red, Blue and Green with sub-frame rate of 360 Hz which is equivalent with 120 Hz of total frame rate. When Red light emission time frame is activated, the Red incident light hits a mirror first, and then the Red beam direction is changed toward a PSS-LCD panel with very shallow incident angle such as less than 30 degrees as illustrated in FIG. 5. This incident light travels in the PSS-LCD panel and goes out to the projection lens. In next time sequence, Blue primary color light repeats same process with the Red primary color light. One of the examples of the time sequential timing is shown in FIG. 7. FIG. 7 shows total frame rate of 120 Hz, or sub-frame rate of 360 Hz. At the first sub-frame, 0 ms to 2.6 ms with 0.2 ms of blanking period, Red light has emission. Synchronizing this emission, the PSS-LCD panel is open for this Red incident light. The total light throughput is the result of this open area and light emission. At the consecutive sub-frame, Blue light emission comes to next. The total light throughput at this particular sub-frame is the same with that in Red sub-frame. The most significant characteristic property of this Invention is amount of light throughput by PSS-LCD panels. Although current existing LCD panel technologies enable same type of optical system, due to strong viewing angle dependence of light throughput, none of current existing LCD panel technologies enable practically acceptable light throughput in such an off-axis incident light optical system. The other element which enables this particular Invention is extremely fast optical response of PSS-LCD panels. Wide viewing angle or wide angle enough light throughput is most necessary to enable this Invention, however, extremely fast optical response meeting with total of over 300 Hz of frame rate is also indispensable factor of this Invention. One of the drawbacks of field sequential color system is its color braking problem. Due to RGB sequential color emission, slow frame rate sometimes provides clearly perceptive single color image depending on relative movement between human eye and the image on the field sequential color image. To avoid color braking problem at field sequential color display, it is well known that at least total of 120 Hz of frame rate is the most necessary. The total of 120 Hz of frame rate requires sub-frame of 360 Hz. This requires optical response time of less than 2 ms at each sub-frame. Among known LCD technologies, some LCDs such as OCB-LCD provide 2 ms of optical response time. However, the 2 ms of response time is realized only between 0 to 1 type response, or non-gray-scale response. So far, except for a PSS-LCD, none of known LCDs have shorter than 5 ms of response time at their inter-gray-scale response. Ferroelectric liquid crystal displays or FLCDs are known to have an extremely fast optical response satisfy fast enough optical response for filed sequential color displays. However, FLCDs have no capability to show continuous gray scale, or analog gray scale. At a field sequential color display, without analog gray scale capability, it is required to create gray scale with so called digital gray scale. Moreover, due to requirement of DC-balance, FLCDs loses light throughput in the half period of the frame. This is critical issue as a projector application.

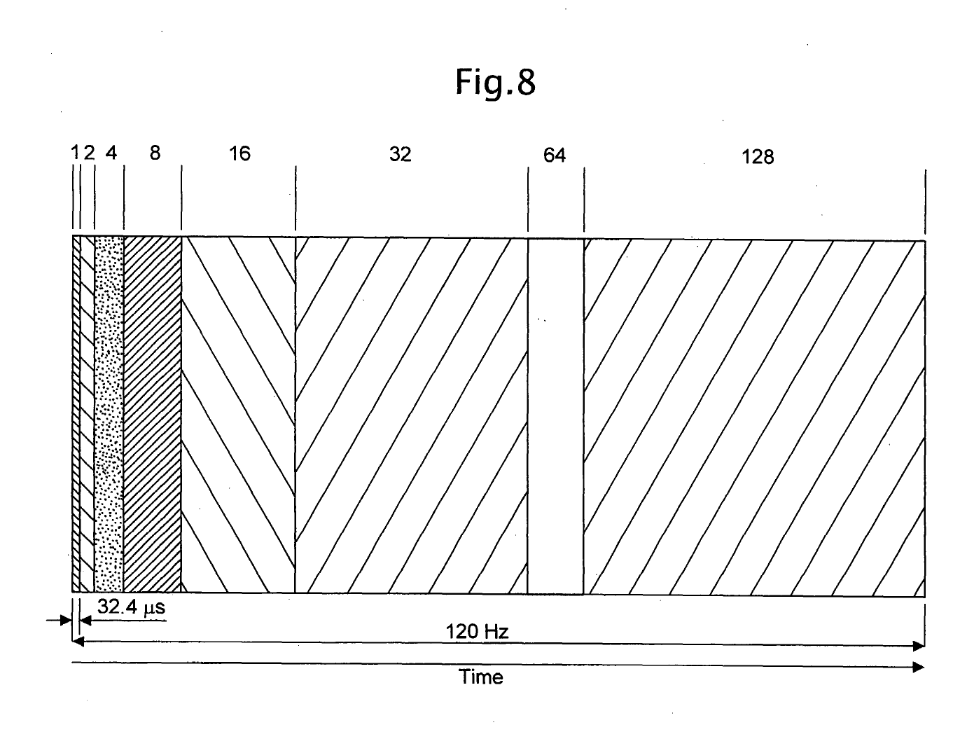

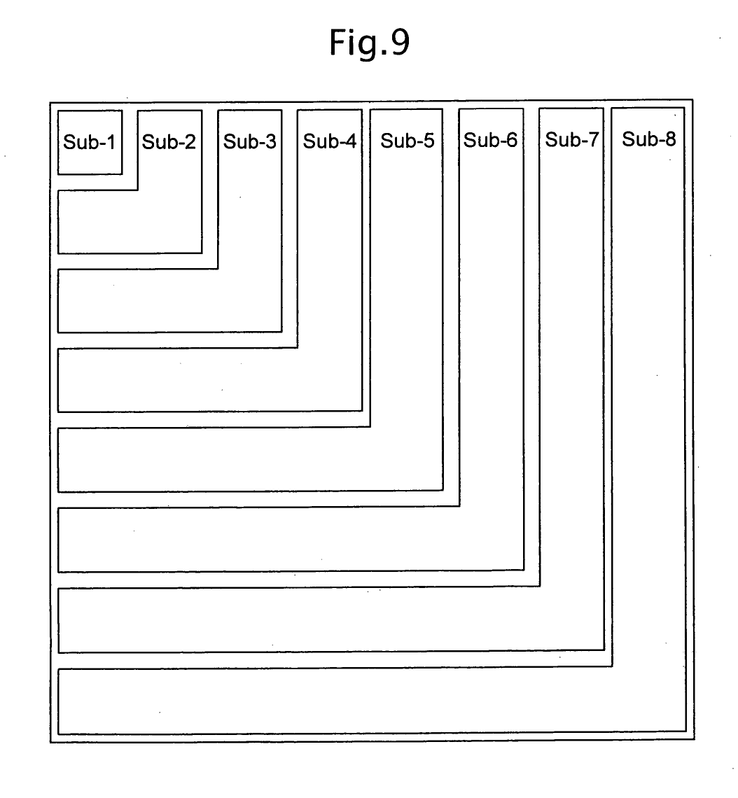

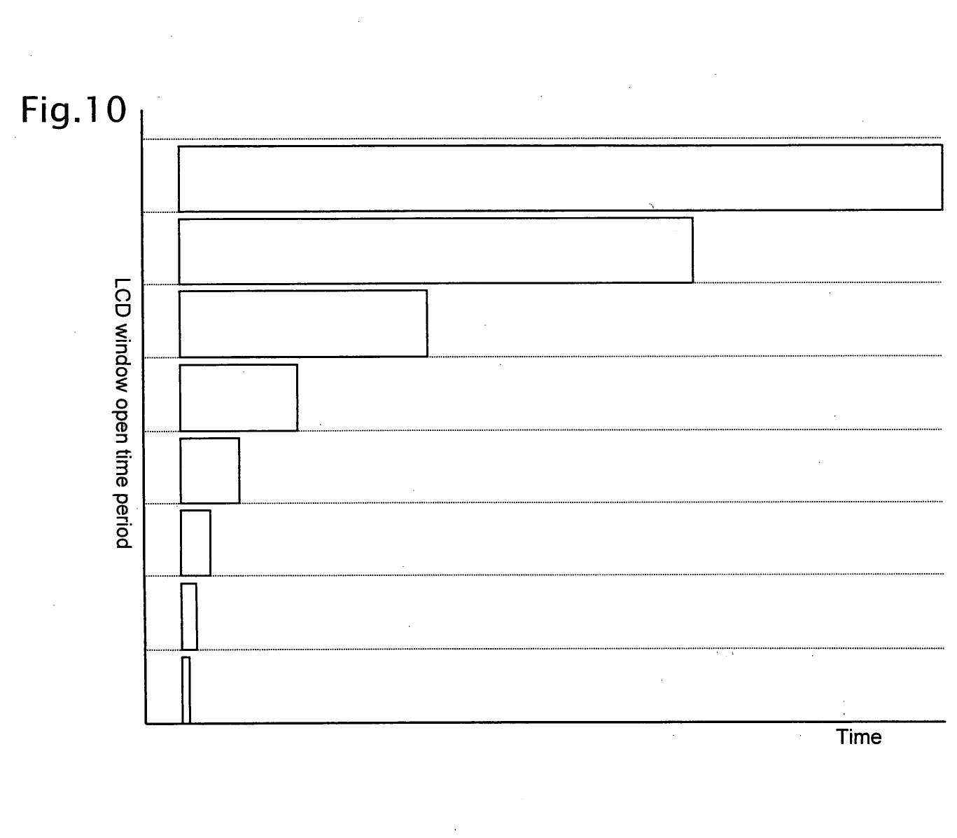

There are couple of methods are known in digital gray scale. One is a combination of sub-frames which is being used at Plasma Display Panels or PDPs. Dividing one full-frame to 8 sub-frames, each divided sub-frame has different light throughput in its light intensity such as 1:2:4:8:16:32:64:128 as shown in FIG. 8. Unlike PDPs, LCDs do not emit by itself, so that illumination light source is required. The principle function of LCDs is the optical switching shutter. Therefore, at this PDP type of digital gray scale method, required optical response time of LCD is 32.4 micro-second as shown in FIG. 8. This required optical response is the case of total frame rate of 120 Hz or sub-frame rate of 360 Hz. If faster frame rate is necessary to avoid any color braking issues, total frame rate of 180 Hz or 240 Hz is required. At 180 Hz of total frame rate, liquid crystal display response is needed shorter than 7 micro-second, and at 240 Hz of total frame rate, shorter than 5 micro-second is necessary. Such a fast optical response is not covered by FLCDs. So far, none of LCD technologies including PSS-LCDs realize this level of fast optical response. Therefore, PDP type of digital gray scale is not applicable for LCDs. The other digital gray scale is so called dithering method. This is basically spatial divided gray scale. Instead of using time domain division such as PDP type of digital gray scale described above, dithering method uses spatial division. As illustrated in FIG. 9, 8 divided sub-pixel in a full one pixel makes 256 scales different optical intensity. The 8 divided each sub-pixel area must has different area such as 1:2:4:8:16:32:64:128 to create 256 gray scale just like PDP type digital gray scale creates in time domain. The dithering digital gray scale creates well enough gray scales in spatial domain. The problem of this digital gray scale method is its requirement of extremely fine sub-pixel structure as well as too much complicated electrode structure. For example, a case of total full pixel size is 20×20 micron, the smallest line width is 0.08 micron as shown in FIG. 10. This extremely small line width is impossible to realize using current known technologies in lithography field. Even this line width is realized with some novel technology, as an optical display device using visible light source whose typical wavelength is 0.56 micron could not control light intensity due to no interaction with too small size compared to light wavelength. Therefore, it is clear that dithering method does not provide solution to the digital gray scale. The other digital gray scale method is so called pulse width modulation. This method has some similarity with PDP type of digital gray scale in terms of time domain usage. The largest difference of the pulse width modulation with PDP type digital gray scale method is use of accumulated optical light throughput as illustrated in FIG. 10. Due to LCD's principle function as optical switching shutter, time domain divided response as shown in FIG. 10 enables digital gray scale. Even this method requires minimum optical response of 10 micro-second to obtain 8-bit each color gray scale at total frame rate of 120 Hz. By sacrificing lower gray scales which requires fast optical response such as 10, 20, and 40 micro-second, this method enables digital gray scales using extremely fast optical response LCD technologies such as FLCDs, and PSS-LCDs. However, due to poor gray scale reproduction, this method is also not acceptable, in particular for well enough image quality of gray scale requirement.

Combination of pulse width modulation and dithering method may provide acceptable image quality as a digital gray scale. However, this combination provides huge cost burden. As explained above, one of the drawbacks of the dithering method is its complicated pixel structure as well as too many drive electrode requirement. Because, each sub-pixel requires its own drive electronics. For instance, WXGA of total pixel numbers, which is 1,280×768=983,040 pixels, requires 983,040×8=7,864,320 pixels at the dithering digital gray scale method. Using pulse width digital gray scale in partially, for instance 2-bit with pulse width modulation, and 6-bit with dithering, required specifications for optical response time and number of sub-pixels are 1.4 ms and 5,898,240 pixels, respectively. These numbers are better than that for each method, respectively, however, still 1.4 ms is too fast for most of LCD technologies, and number of sub-pixel has both technical limitation of its pixel size and cost problem. Therefore, it is clear that digital gray scale methods provide any of practical solution using LCD technologies. On the contrary, analog gray scale does not have any problems in number of pixels except for still required very fast optical response time such as shorter than 1 ms. PSS-LCDs have fast enough optical response including inter-gray-scale response.

It is obvious from FIG. 7 that faster optical response provides brighter light throughput. Because of rise and fall process of light throughput, total light throughput is dependent on both response profile and transmittance (or reflectance) of the liquid crystal panel. The transmittance (or reflectance) includes incident light angle dependence of light throughput. Therefore, both of wide incident angle light throughput and fast optical response are the two principle factors to realize this Invention.

As the conclusion, very fast optical response with inter-gray-scale and having extremely wide viewing angle of the PSS-LCD technology is the only possible solution both in technical requirement and economical requirement in this particular Invention.

Hereinbelow, the present invention will be described in more detail with reference to specific Examples.

### EXAMPLES

### Example 1

(This Invention)

Using reflective silicon backplane specifically designed for Twisted Nematic (TN) liquid crystal display with pixel resolution of VGA (640×480), so called LCOS or Liquid Crystal on Silicon panel is prepared with PSS-LCD technology. The diagonal size of the silicon backplane is 0.55 inches. The small 0.55-inch silicon dye is cleaned by neutral detergent and rinsed by pure water. The top surface of the silicon backplane is mostly covered by aluminum-cupper alloy, therefore, strong alkaline cleaner is not available. After the pure water lines and dried, the silicon backplane is also cleaned by UV cleaner as dry cleaning. The other substrate prepared is ITO coated glass substrate whose size is 0.65 inches diagonal. This ITO coated glass substrate is a simple ITO coated one without any pixilation. This ITO coated glass is cleaned using PH 11 of strong alkaline cleaner, and then rinsed by pure water.

After cleaned respectively, both top surfaces of the substrates are coated by poly-imide by spin coating machine. The coated thickness of poly-imide is 400 A for silicon dye, 300 A for ITO substrate, respectively after cured by a clan oven. After the curing of poly-imide, the top surface of the poly-imide is buffed by a buffing machine. A UV and thermo type of glue is used for this LCOS panel lamination. Silicon particles mixed glue is dispensed at peripheral area of ITO glass substrates. The used silicon particles have an average diameter size of 0.9 micron. After laminated by this silicon particle mixed glue, UV and thermo are applied, and an empty reflective panel is prepared.

A PSS liquid crystal material made by home made mixture is filled into this empty panel by using a vacuum with thermo application method. The filled maximum temperature is 100 degrees C. After the fill process, the fill hole is chipped off by UV glue.

Using this prepared reflective PSS-LCD panel, reflective optical system is prepared as shown in FIG. 5. The prepared optical component is: (1) reflective PSS-LCD panel, (2) mirror with size of 20 mm×15 mm×1.1 mm, (3) RGB selective wavelength laser, (4) Concave lens with diameter size of 25 mm, and (5) a pair of polarizers. For light source, RGB LED lamps are also available. Here, for the purpose of confirmation of function of this Invention, RGB selective wavelength light source is used.

The prepared PSS-LCOS panel is driven by using standard driving unit designed for TN-LCD with one modification. In order to confirm field sequential color image creation, frame rate is changed from original 60 Hz of total rate to 120 Hz of total rate. This change is very simple, just changed signal timing with clock rate change. A personal computer is used as signal source. In order to confirm basic performance as a field sequential color system at this Invention. Total red image, total green image, total blue image, and total white image are first input to the PSS-LCOS panel. Then, mixed color image such as yellow, pink, blue green color images are confirmed. Then, finally continuous gradation from white to back images are displayed. Using set-up shown in FIG. 5, these primary colors, mixed colors, and continuous gradation color images are confirmed without showing color braking problems.

Next, the light efficiency is measured as the function of incident angle to the PSS-LCOS panel. Table 1 summarizes the result of the measurement. As shown in Table 1, this Invention realizes over 80% of light efficiency with 40 degrees of off-axis incident angle.

### [Table 1] Light Efficiency for Example 1 (This Invention)

TABLE 1

| φ (deg.) | Light efficiency (%) |
|---|---|
| 0 | 100 |
| 10 | 98 |
| 20 | 94 |
| 30 | 90 |
| 40 | 86 |
| 50 | 82 |
| 60 | 80 |
| 70 | 77 |

### Example 2

(Control)

Using exactly same optical set-up described Example 1 (FIG. 5), only reflective LCD panel is substituted to TN type of LCOS panel.

First, the TN type of LCOS panel is applied the same time sequential signal, which is total frame rate of 120 Hz. Using the same color patterns applied to 4.1 for PSS-LCOS panel, the projected screen color is measured by CA-210 system (Konica-Minolta). Due to slow response of TN-LCD, pure primary colors could not be obtained. Instead of obtaining primary color, mixed color image is obtained for R,G, and B primary color signal input. For mixed color signal input, obtained screen image color is very different from the input signal colors.

Using white signal, light efficiency is measured as the function of incident light angle to the TN-LCOS panel. Table 2 summarizes the result of the measurement. Comparison between Table 1 and Table 2 shows obvious difference in light efficiency between the PSS-LCOS panel and the TN-LCOS panel.

### [Table 2] Light Efficiency for Example 2 (Control)

TABLE 2

| φ (deg.) | Light efficiency (%) |
|---|---|
| 0 | 100 |
| 10 | 81 |
| 20 | 73 |
| 30 | 40 |
| 40 | 21 |
| 50 | —* |
| 60 | —* |
| 70 | —* |

*unable to measure

### Example 3

(This Invention: Different Set-Up)

Using reflective silicon backplane specifically designed for Twisted Nematic (TN) liquid crystal display with pixel resolution of VGA (640×480), so called LCOS or Liquid Crystal on Silicon panel is prepared with PSS-LCD technology. The diagonal size of the silicon backplane is 0.55 inches. The small 0.55-inch silicon dye is cleaned by neutral detergent and rinsed by pure water. The top surface of the silicon backplane is mostly covered by aluminum-cupper alloy, therefore, strong alkaline cleaner is not available. After the pure water lines and dried, the silicon backplane is also cleaned by UV cleaner as dry cleaning. The other substrate prepared is ITO coated glass substrate whose size is 0.65 inches diagonal. This ITO coated glass substrate is a simple ITO coated one without any pixilation. This ITO coated glass is cleaned using PH 11 of strong alkaline cleaner, and then rinsed by pure water.

After cleaned respectively, both top surfaces of the substrates are coated by poly-imide by spin coating machine. The coated thickness of poly-imide is 400 A for silicon dye, 300 A for ITO substrate, respectively after cured by a clan oven. After the curing of poly-imide, the top surface of the poly-imide is buffed by a buffing machine. A UV and thermo type of glue is used for this LCOS panel lamination. Silicon particles mixed glue is dispensed at peripheral area of ITO glass substrates. The used silicon particles have an average diameter size of 0.9 micron. After laminated by this silicon particle mixed glue, UV and thermo are applied, and an empty reflective panel is prepared.

A PSS liquid crystal material made by home made mixture is filled into this empty panel by using a vacuum with thermo application method. The filled maximum temperature is 100 degrees C. After the fill process, the fill hole is chipped off by UV glue.

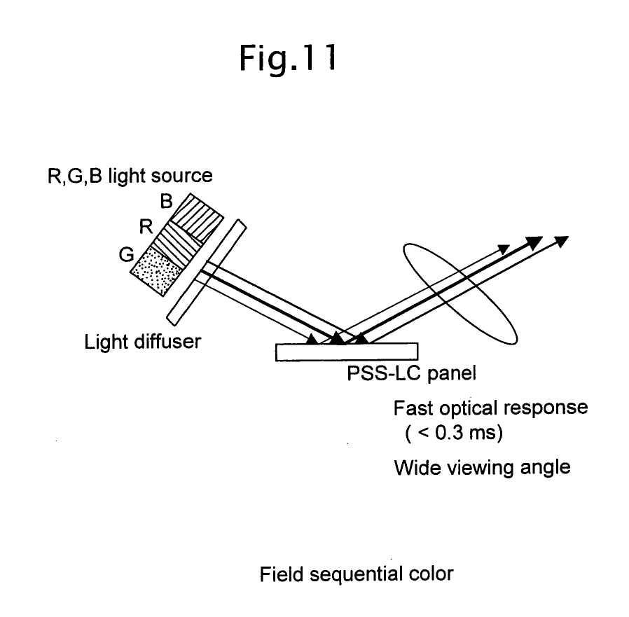

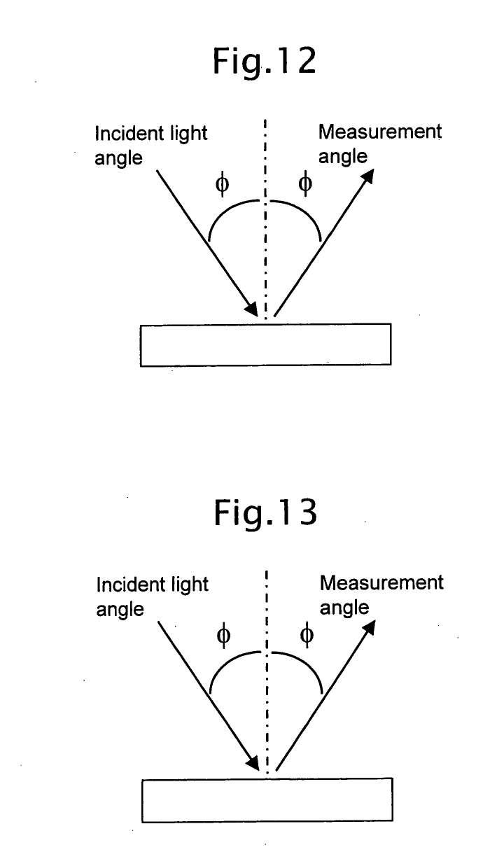

Using this prepared reflective PSS-LCD panel, reflective optical system is prepared as shown in FIG. 11. The prepared optical component is: (1) reflective PSS-LCD panel, (2) light diffuser with size of 15 mm×15 mm×3 mm, (3) RGB selective wavelength laser, (4) Concave lens with diameter size of 25 mm. For light source, RGB LED lamps are also available. Here, for the purpose of confirmation of function of this Invention, RGB selective wavelength light source is used.

The prepared PSS-LCOS panel is driven by using standard driving unit designed for TN-LCD with one modification. In order to confirm field sequential color image creation, frame rate is changed from original 60 Hz of total rate to 120 Hz of total rate. This change is very simple, just changed signal timing with clock rate change. A personal computer is used as signal source. In order to confirm basic performance as a field sequential color system at this Invention. Total red image, total green image, total blue image, and total white image are first input to the PSS-LCOS panel. Then, mixed color image such as yellow, pink, blue green color images are confirmed. Then, finally continuous gradation from white to back images are displayed. Using set-up shown in FIG. 11, these primary colors, mixed colors, and continuous gradation color images are confirmed without showing color braking problems.

Next, the light efficiency is measured as the function of incident angle to the PSS-LCOS panel. Table 3 summarizes the result of the measurement. As shown in Table 3, this Invention realizes over 80% of light efficiency with 40 degrees of off-axis incident angle.

### [Table 3] Light Efficiency for Example 3 (This Invention)

TABLE 3

| φ (deg.) | Light efficiency (%) |
|---|---|
| 0 | 100 |
| 10 | 97 |
| 20 | 93 |
| 30 | 89 |
| 40 | 85 |
| 50 | 82 |
| 60 | 80 |
| 70 | 76 |

### Example 4

(Control)

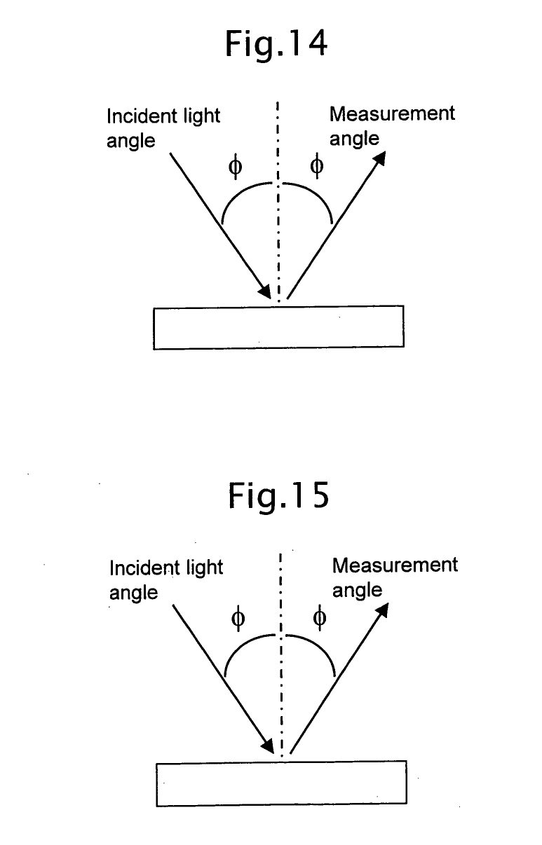

Using exactly same optical set-up described Example 3 (FIG. 14), only reflective LCD panel is substituted to TN type of LCOS panel.

First, the TN type of LCOS panel is applied the same time sequential signal, which is total frame rate of 120 Hz. Using the same color patterns applied to 4.1 for PSS-LCOS panel, the projected screen color is measured by CA-210 system (Konica-Minolta). Due to slow response of TN-LCD, pure primary colors could not be obtained. Instead of obtaining primary color, mixed color image is obtained for R,G, and B primary color signal input. For mixed color signal input, obtained screen image color is very different from the input signal colors.

Using white signal, light efficiency is measured as the function of incident light angle to the TN-LCOS panel. Table 4 summarizes the result of the measurement. Comparison between Table 3 and Table 4 shows obvious difference in light efficiency between the PSS-LCOS panel and the TN-LCOS panel.

### [Table 4] Light Efficiency for Example 4 (Control)

TABLE 4

| φ (deg.) | Light efficiency (%) |
|---|---|
| 0 | 100 |
| 10 | 78 |
| 20 | 69 |
| 30 | 37 |
| 40 | 20 |
| 50 | —* |
| 60 | —* |
| 70 | —* |

*unable to measure

### EFFECT OF THIS INVENTION

This Invention realizes effective off-axis projection display system with very high light efficiency. This technical achievement of this Invention also realizes extremely simple and cost effective projection system. The simple optical system utilizing the minimum requirement of optical component also gives rise to optical design freedom. Thanks to the design freedom, first of all, extremely small volume projection system is realized.

Second, very easy optical component assembling is realized.

Third, both high light efficiency and cost saving with minimum use of optical component are realized with high level of compatibility between light efficiency and cost saving. The reduction of used optical component reduces surface reflection, which is one of the significant causes of light loss or reduction of light efficiency. This Invention's off-axis optical system enables reduction of required optical component, resulting in even higher light efficiency.

From the invention thus described, it will be obvious that the invention may be varied in many ways. Such variations are not to be regarded as a departure from the spirit and scope of the invention, and all such modifications as would be obvious to one skilled in the art are intended to be included within the scope of the following claims.

What is claimed is:

1. A projection display system comprising;
a liquid crystal display panel comprising at least a pair of substrates; and a liquid crystal material disposed therebetween; and
projection means comprising an off-axis incident light source.

2. A projection display system comprising according to claim 1, wherein the liquid crystal display panel uses PSS-LCD technology.

3. A projection display system according to claim 1, wherein the off-axis incident angle is over 10 degrees.

4. A projection display system, a liquid crystal display panel comprising at least a pair of substrates; and a liquid crystal material disposed therebetween; and
a projection means comprising an off-axis incident light source
wherein the projection system comprises a reflective PSS-LCD panel, mirror, Red, Blue, and Green selective wavelength light source, concave lens, and a pair of polarizers.

5. A projection display system according to claim 4, wherein the projection system does not use polarized beam splitter.

6. A projection display system according to claim 1, wherein the projection system has Red, Green, and Blue primary color light source.

7. A projection display system according to claim 3, wherein the off-axis incident angle is introduced to a reflective PSS-LCD panel with over 10 degrees of off-axis angle.
